(19) United States
(12) Patent Application Publication
(10) Pub. No.: US 2002/0171191 A1
(43) Pub. Date: Nov. 21, 2002

(54) Self attaching, non-slipping, non-marring, long lasting, low cost, replaceable, soft, universal vise jaw covers

(76) Inventor: Richard C. Hudson, Austin, TX (US)

Correspondence Address: Richard C. Hudson, 1315 Warrington Dr., Austin, TX, 78753, US

(21) Appl. No.: 10/094,469

(22) Filed: Mar. 8, 2002

Related U.S. Application Data
(60) Provisional application No. 60/274,182, filed on Mar. 9, 2001.

(51) Int. Cl. B25B 1/24

(52) U.S. Cl. 269/279

(57) ABSTRACT

A universal vise jaw cover comprising an elongated flat panel of resilient material, such as leather, of predetermined length, width, and thickness with a system of self-attachment applied to the backside of the vise jaw cover. The system or systems of self-attachment can be of differing forms. One form is when an adhesive material is applied to the backside of the vise jaw cover and the exposed adhesive material is then applied to the front side of the vise jaw. Another form is when a flexible magnetic material is glued with epoxy or adhesive material to the backside of the vise jaw cover and when the vise jaw cover is applied to a vise jaw of ferrous material, the magnetic material will hold the vise jaw cover in place while the vise is not in use.

### CROSS REFERENCE TO RELATED APPLICATIONS

This application is related to U.S. Provisional application No. 60/274,182 by applicant filed Mar. 9, 2001, and claims priority from the filing date of that provisional application.

### BACKGROUND

1. Field of Invention

This invention relates to vise jaw covers, specifically to such that are meant to protect a work piece or tool from damage that is often caused by the metal jaws of a vise and to protect the vise from materials that can cause damage or excessive wear to the vise.

2. Description of Prior Arts

A piece of equipment or tool that is commonplace in almost every workshop or garage is a mechanical work holding devise or commonly known as a bench vise or a machine vise. Vises are used to hold a work piece securely while the work piece is being altered in some form or fashion. Some examples of alteration would include, sawing, drilling, filing, bending, hammering, wrenching, gluing, and painting and or a combination there of.

The metal jaws of vise are good for holding items that have at least two flat surfaces that are in parallel plains to each other securely and or the surface of the item being held by the vise will not be damaged or if marks left by the metal jaws of the vise are not relevant to the overall condition of the work piece being held in the vise.

Unfortunately the afore mentioned conditions are not always the case. Very often a work piece or a tool does not have two flat surfaces that are in parallel plains to each other. The opposing surfaces of a work piece often can have non-flat surfaces that are not in parallel plains to each other, differing contours, and irregular surfaces. A work piece or tool can have textured surfaces and or easily scratched or marred surfaces.

Very often the metal jaws of a vise are made of steel that has been hardened to some degree for durability and has some form of serrations to help enhance the gripping or holding ability of the vise. More often than not a work piece is made of material that is softer than the material of the vise jaw. If a work piece is softer than the jaws of the vise, more often than not mars or marks will be left on the work piece by the hardness of the material of the vise jaw and or the serrations on the vise jaws.

Tools are often hardened or tempered to give more strength and durability to the tool. If a tool is held in the metal jaws of vise, the tool and the vise can be damaging to each other. If a tool or a work piece is decidedly harder than the jaws of a vise and is brittle, an example such a work piece would be a piece of glass and an example of such a tool would be a sharpening stone, the pressure and hardness of the metal jaws of the vise could easily crack or crush such objects.

Vises are good useful tools and with a simple added accessory their range of usefulness can be greatly increased.

There have been other attempts to overcome the afore mentioned problems, but they do not seem to be as well thought out as they could have been. U.S. Pat. No. 4,252,305 to Pasch 1981 discloses a vise jaw cover that is designed to cover the working surface or jaw face of a vise, the panel made from a soft, resilient, compressible material such as latex rubber.

One shortcoming of this vise jaw cover is the suggested material. Latex rubber will be easily be cracked and split when pressure is applied by objects being held in a vise that is employing this kind of vise jaw cover.

Another problem is the expense of manufacturing in materials and processing. In addition, although the idea is simple and straightforward it has the basic presentation of being a puzzle. Some people may find such a devise somewhat difficult to install.

U.S. Pat. No. 4,569,511 to Bell, Jr. (1986) discloses a vise pad that has an L-shaped cross section that could be made of a flexible material such as poly vinyl chloride. This design is an improvement to a to a vise, but the PVC tends to have a good memory for recording the shape and imprint of every object that has been held in the vise. This attribute will tend to lessen the useful life of this vise jaw pad design. Another limiting factor is the thickness of the material used to make the vise pad. The thickness of the vise pad will greatly limit the width opening capacity of the vise. The expense of producing this vise pad would be high and price to the consumer may be more than the benefits realized.

U.S. Pat. No. 5,246,216 to Oberst 1993 discloses a vise jaw attachment for irregular shapes. It is a vise jaw pad that is comprised of a pouch that has pellets inside. The pellets are meant to move freely inside of the pouch in order to conform to a particular irregular shape of an object being held in a vise.

The concept of this invention does deserve some consideration, but in practice the proposed design and structure is limiting. If the seams of the pouch were to break through use of this invention the pellets would be lost rendering the vise pad unusable.

### SUMMARY

In accordance with the present invention a universal vise jaw cover that is self attaching, non-slipping, non-marring, long lasting, soft, low cost, and disposable comprises a flat panel having a system of self-attachment applied to its backside.

### OBJECTS AND ADVANTAGES

Accordingly, besides the objects and advantages of the universal vise jaw cover described in my patent above, several objects and advantages of the present invention are:

(a) to provide a vise jaw cover which will increase the value of a vise be increasing the useful range and holding ability of a vise;

(b) to provide a vise jaw cover which allows a wider variety of items to be held in a vise with little or no damage being caused by the pressure or the materials of the jaws of the vise;

(c) to provide a vise jaw cover which a delicate object will be held securely in a vise while causing no or negligible damage to the work piece;

(d) to provide a vise jaw cover which will allow soft easily scratched materials such as soft metals (silver, gold, brass, copper, aluminum, etc.) and other easily damaged materials such as plastics, wood, glass, and other materials to be held in a vise with little or no damage occurring;

(e) to provide a vise jaw cover that will allow tools to be held in a vise safely with no damage being caused to the tool or the vise.

(f) to provide a vise jaw cover that will cushion easily damaged or easily broken objects and allow them to be held securely in a vise;

(g) to provide a vise jaw cover that is tough enough to handle moderate to heavy work load expectations without slipping;

(h) to provide a vise jaw cover that is of a solid piece construction:

(i) to provide a vise jaw cover that increases the grip of a vise by conforming to the shape, contour, profile, and texture of an object being held in vise;

(j) to provide a vise jaw cover that can be fabricated in variety of materials to meet specific requirements for specific applications;

(k) to provide a vise jaw cover that can increase the useful life a vise by protecting the vise against excessive wear;

(l) to provide a vise jaw cover that can provide protection and insulation to a vise against objects that may be too hard, hot, cold, acidic, high in alkaline, rough, sharp, electrically charge, etc;

(m) to provide a vise jaw cover that is self attaching to the jaws of a vise;

(n) to provide a vise jaw cover that has one or more of the following applied to its back flat side—adhesive material with a protective covering to protect against exposure to foreign substances until such time when the vise jaw cover is to be put in use, a sticky hard wax substance with said type of protective covering, a piece of flexible plastic strip magnet.

Further objects and advantages are to provide a vise jaw cover which can be used easily and conveniently on any vise in use, which is simple to use and inexpensive to manufacture. Still further objects and advantages will become apparent from a consideration of the ensuing description and drawings.

### DRAWING FIGURES

FIG. 1 shows a mechanical work holding devise that can be commonly referred to as a vise that shows the vise jaw covers installed.

FIG. 2 illustrates, in perspective view, the vise jaw cover is shown with the construction of the base of closure, adhesive layer, and the protective backing sheet.

FIG. 3 illustrates, in perspective view, the vise jaw cover is shown with the construction of the base of closure, and the epoxy layer that bonds the flexible magnetic material to the leather strip.

FIG. 4 illustrates, in front view, the front side of the base of closure that has a surface that is textured, by embossing, scoring, carving or molding.

### REFERENCE NUMERALS IN DRAWINGS

| | |
|---|---|
| 10 base of closure | 12 vise |
| 14 vise jaw | 16 adhesive material |
| 18 protective backing | 20 epoxy material |
| 22 flexible magnetic material | 24 smooth front surface |
| 26 textured front surface | 28 lever handle |

### DISCRIPTION

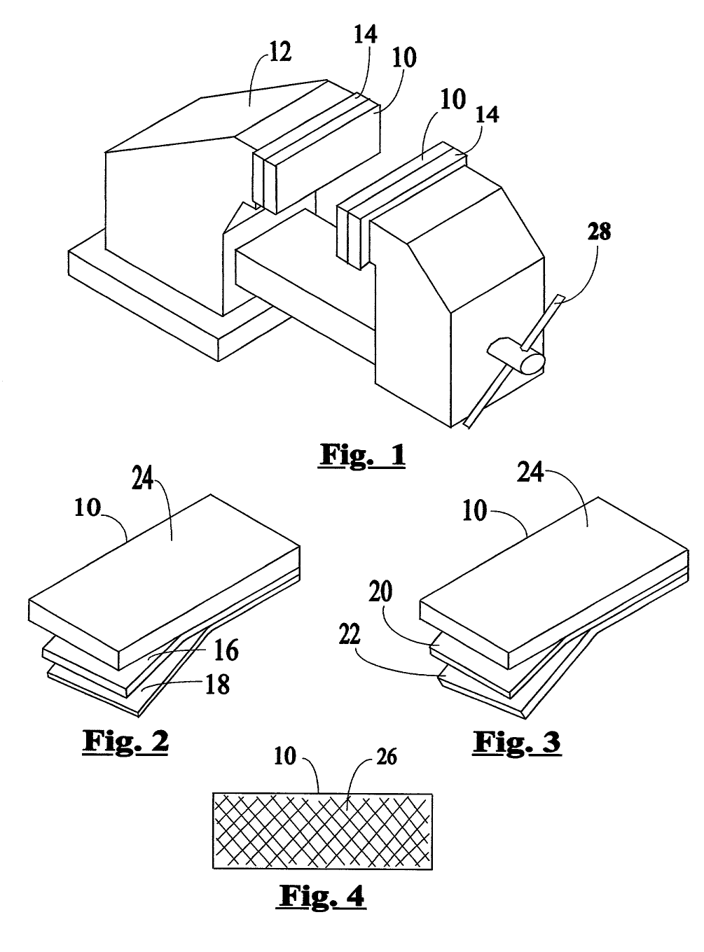

FIGS. 1 and 2 and 4—Preferred Embodiments

A preferred embodiment of the closure of the present invention is illustrated in FIG. 1 and FIG. 2 and FIG. 4. The closure has a panel 10 of uniform cross section consisting of a sheet of resilient material that can have a smooth front surface 24 (FIG. 1) or a textured front surface 26 (FIG. 4) which can be repeatedly compressed with out breaking, fracturing, or being greatly deformed. One or more layers of an adhesive type material 16 (FIG. 2) is applied to the back side of base 10. In order to protect the adhesive layer until use one layer of a protective backing material 18 is applied or pre-applied to the outer most surface of the adhesive type of material 16. In the preferred embodiment the base 10 is leather. However, the base can consist of any other resilient material that can be repeatedly compressed without breaking, fracturing, splintering or being greatly deformed. Such as plastic, rubber, paper, cardboard, composite materials, wood, or combinations there of.

FIG. 2—Additional Embodiments

An additional embodiment is shown in FIG. 3. In this case the base 10 has a panel of flexible magnetic material 22 that has been bonded to the backside of the base 10 by an epoxy type of material 20. The strongest magnetic side of the flexible magnetic material 22 is facing away from the base 10.

Advantages

From the description above, a number of advantages of this invention become evident:

(a) The use of adhesive material or magnetic material applied to the backside of these vise jaw covers make them self-attaching.

(b) The self-attaching attribute makes these vise jaw covers a universal attachment and an improvement to virtually any vise.

(c) The use of these vise jaw covers protect a work piece or tool against damage that could be incurred by direct contact with the metal jaws of a vise.

(d) The use of these vise jaw covers protect and extend the useful life of a vise.

(e) These vise jaw covers are removable, and reusable, and replaceable.

(f) The use of leather that is highly compressible making the vise jaw cover highly resistant to cracking or breaking.

(g) The use of flexible magnetic material that is highly compressible making the magnetic attachment highly resistant to cracking or breaking.

Operation

The manner of using base 10 is identical to that for vise jaw 14 in present use. Namely a work piece or tool is placed between the vise jaws 14 and pressure is applied by turning the lever handle 28 of the vise 12. This allows the vise 12 to hold a work piece or tool securely.

Base 10 acts as a servant or a helper to the vise jaw 14. With base 10 attached to the vise jaw 14 a much greater variety of items can be held safely and securely since base 10 has the ability to conform to the contours, profiles, and surface textures of a work piece or tool that is being held in a vise 12.

Conclusion, Ramifications, and Scope

Accordingly, the reader will see that the vise jaw covers of this invention do increase the value of a vise by greatly increase the variety of objects that can be held in a vise safely and securely with little or no damaged being incurred by the metal jaws of a vise. It can be readily seen that I have provided a novel and improved vise jaw cover that is easily installed and will increase the usability of a vise while at the same time protect the vise against unnecessary wear.

In consideration of this invention, it should be remembered that the present disclosure is illustrative only and the scope of the invention should be determined by the appended claims.

What is claimed is:

1. A vise jaw cover comprising:
a leather strip having an outer surface and an inner surface;
at least one adhesive layer, of substantially the same shape as the leather strip, the adhesive layer having a first surface applied to the inner surface of the leather strip, and a second surface; and
a removable backing sheet, of substantially the same shape as the leather strip, attached to the second surface of the adhesive layer, such that the backing sheet may be removed, and that the second surface of the adhesive layer may be secured to the vise jaw.

2. The vice jaw covering of claim 1 wherein
the outer surface of the leather strip is smooth.

3. The vice jaw covering of claim 1 wherein
the adhesive layer is a double-sided tape.

4. The vice jaw covering of claim 1 wherein
the leather strip has a thickness of 0.06 to 0.18 inches.

5. The vice jaw covering of claim 1 wherein
the leather strip has a length of 3.00 to 10.00 inches, and a width of 0.50 to 2.00 inches.

6. A vise jaw cover comprising:
a leather strip having an outer surface and an inner surface;
at least one adhesive layer, of substantially the same shape as the leather strip, the layer having a first surface applied to the inner surface of the leather strip, and a second surface; and
a removable backing sheet, of substantially the same shape as the leather strip, attached to the second surface of the adhesive layer, such that the backing sheet may be removed, and that the second surface of the adhesive layer may be secured may be secured to the vise.

7. The vise jaw covering of claim 6 wherein
the adhesive layer is a double sided tape

8. The vise jaw covering of claim 6 wherein
the outer surface of the leather strip is not smooth.

9. The vise jaw covering of claim 6 wherein
the adhesive layer is a double sided tape.

10. The vise jaw covering of claim 6 wherein
the leather strip has a thickness of 1/16 inch to ⅜ inches.

11. The vise jaw covering of claim 6 wherein
the leather strip has a length of 3 inches to 10 inches and a width of ½ inch to 3 inches

12. A vise jaw cover comprising:
a leather strip having an outer surface and an inner surface;
an expoy layer having a first surface applied to the inner surface of the leather strip, and a second surface; and
a flexible magnetic strip having a first surface applied to the second surface of the epoxy layer, and a second surface, such that the second surface may be magnetically secured to the vise jaw.

13. The vice jaw covering of claim 12 wherein
the adhesive layer is a two part epoxy glue.

14. The vice jaw covering of claim 12 wherein
the magnetic strip is substantially the same shape as the leather strip.

15. The vice jaw covering of claim 12 wherein
the leather strip has a thickness of 1/16 inch to ⅜ inch.

16. The vice jaw covering of claim 12 wherein
the leather strip has a length of 3 inches to 10 inches, and a width of ½ inches to 3 inches.
